(19) United States
(12) Patent Application Publication
(10) Pub. No.: US 2005/0285841 A1
(43) Pub. Date: Dec. 29, 2005

(54) Video display driving method of an LCD

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/094,295

(22) Filed: Mar. 31, 2005

(30) Foreign Application Priority Data
Jun. 25, 2004 (TW) 093118629

(51) Int. Cl. G09G 3/36

(52) U.S. Cl. 345/102

(57) ABSTRACT

A video display driving method of an LCD includes the following processes. A data transforming process transforms plural sets of video frame data into a plurality of preset voltage signal sets and post-set voltage signal sets. A display driving process writes at least one preset voltage signal of a first preset voltage signal set and at least one post-set voltage signal of a first post-set voltage signal set into at least one pixel during a frame time. During a next frame time, the display driving process then writes a preset voltage signal of a second preset voltage signal set and a post-set voltage signal of a second post-set voltage signal set into the pixel. A light controlling process controls the brightness of a backlight module, so that at the location of the pixel a first average brightness and a second average brightness is produced, and the second average brightness is greater than the first average brightness.

### BACKGROUND OF THE INVENTION

1. Field of Invention

The invention relates to a video display driving method and, in particular, to a video display driving method for eliminating the blurring phenomenon of an LCD (Liquid Crystal Display).

2. Related Art

Regarding to the application fields, the LCDs are used for monitors or televisions. In fact, the structures of the LCDs used for monitors and televisions are similar, and only different in several components, circuits and the layout of some components.

With reference to FIG. 1, a conventional LCD 1 includes an LCD panel 1, a backlight module 2, a driving circuit 3, and a control circuit 4. As shown in FIG. 1, the LCD panel 1 at least includes a liquid crystal layer 11, a color filter substrate 12, a transistor circuit substrate 13, and two polarizers (a polarizer 14 and a polarizer 15). The liquid crystal layer 11 is disposed between the color filter substrate 12 and the transistor circuit substrate 13. The polarizer 14 is disposed at one side of the color filter substrate 12, while the polarizer 15 is disposed at one side of the transistor circuit substrate 13.

Referring to FIG. 1 again, the backlight module 2 includes a lamp case 21 and a power driver 22 for driving lamps. The lamp case 21 at least includes a plurality of lamps 211 and a diffuser 212. The lamps 211 are usually cold cathode fluorescent lamps (CCFL). The driving circuit 3 electrically connects to the LCD panel 1 for driving the LCD panel 1. In general, the driving circuit 3 is composed of a plurality of driving ICs and at least one driving circuit board.

The control circuit 4 is used for controlling the driving circuit 3 so as to control the LCD panel 1. The control circuit 4 and the power driver 22 are commonly installed at one side of the lamp case 21. The lamp case 21 is positioned adjacent to the LCD panel 1, so that the lamps 211 of the lamp case 21 can illuminate the LCD panel 11 and the light of the lamps 211 can be projected on the display surface 16 of the LCD panel 1.

In view of the above-mentioned video display driving method of the LCD, since the liquid crystal material of the liquid crystal layer 11 has slower response time, the blurring phenomenon may occur on the displaying surface 16 of the LCD panel 1 when motion pictures are rendered on the display. To solve this problem, the liquid crystal materials with faster response time are invented recently. However, the LCD panel 1 with the faster response time liquid crystal material is difficult to manufacture. Moreover, even though the faster response time liquid crystal material is used, the blurring phenomenon still occurs on the displaying surface 16 of the LCD panel 1 when motion pictures are rendered. That is a result of the holding-type display mode of the conventional LCD. When watching the motion pictures rendered on the holding-type display, human eyes spontaneously track the moving object in the pictures plus the persistence of vision effect, which make the blurring phenomenon still occur on the displaying surface 16 of the LCD panel 1 even with the liquid crystal material which has fast enough response time.

Hereinafter, the impacts on the video display given by the certain response time of the liquid crystal material will be described with reference to FIGS. 2A to 2D. FIG. 2A shows a voltage signal V₁ that is written into any pixel of the display surface 16 during two frame time. As shown in FIG. 2B, when the response time of the liquid crystal material is slow, the liquid crystal material of the pixel can not reach stable state immediately. Thus, the transmittance of the pixel (as the continuous line shown in FIG. 2B) may not reach the desired transmittance Tr₁ corresponding to the voltage signal V₁ before the end of the first frame time T₁. Even worse, the transmittance of the pixel may not reach the desired transmittance Tr₁ corresponding to the voltage signal V₁ before the end of the frame time T₂. Herein, if the liquid crystal material with faster response time is used, although the transmittance of the pixel (as the continuous line shown in FIG. 2B) may not reach the desired transmittance Tr₁ corresponding to the voltage signal V₁ before the end of the first frame time T₁, it may approach the desired transmittance Tr₁ corresponding to the voltage signal V₁ before the end of the frame time T₂. As shown in FIG. 2C, assuming the luminance of the lamps 211 is L₁, the brightness of the pixel on the displaying surface 16 is as shown in FIG. 2D. Although the liquid crystal with faster response time can make the pixel reach the desired brightness faster, the conventional LCD, however, still utilizes the holding type display mode. Therefore, no matter how fast the response time of the liquid crystal material is, the conventional LCD still shows blurring phenomenon for displaying motion pictures.

Except the above-mentioned solution which utilizes liquid crystal material with faster response time, the over-driving technology had been disclosed, too. As shown in FIG. 3A, an over-driving voltage signal V₂ corresponding to a voltage signal V₁ is written into any pixel of the display surface 16 during a first frame time T₁, and the voltage signal V₁ is written into the pixel of the display surface 16 during a second frame time T₂. As shown in FIG. 3B, since the over-driving voltage signal V₂ is applied during the first frame time T₁, the transmittance of the pixel can approach the desired transmittance Tr₁ corresponding to the voltage signal V₁ before the end of the first frame time T₁. As shown in FIG. 3C, assuming the luminance of the lamps 211 is L₁, and the brightness of the pixel on the displaying surface 16 is as shown in FIG. 3D. The over-driving technology can make a certain effect for improving the response time of the liquid crystal material. However, since the conventional LCD utilizes the holding-type display mode, the blurring phenomenon may not be completely solved by utilizing only the over-driving technology.

Accompanying with the development of the driving technology in backlight module, for solving the blurring phenomenon seen on the holding-type display, the emitted light source is illuminated no longer just uniformly and continuously, but moreover is illuminated blinkingly so as to turn LCDs into the impulse-type displays. Accordingly, a technology combining the over-driving with blinking backlight is invented. As shown in FIG. 4A, an over-driving voltage signal V₂ corresponding to a voltage signal V₁ is written into any pixel of the display surface 16 during a first frame time T₁, and the voltage signal V₁ is then written into the pixel of the display surface 16 during a second frame time T₂. As shown in FIG. 4B, since the over-driving voltage signal V₂ is applied during the first frame time T₁, the transmittance of the pixel can approach the desired transmittance Tr₁ corresponding to the voltage signal V₁ before the end of the first frame time T₁. As shown in FIG. 4C, assuming the luminance of the lamps 211 is L₁ and the duty cycle is 50% of the frame time for blinking illumination, the brightness of the pixel on the displaying surface 16 is as shown in FIG. 4D. As shown in FIG. 4D, since in this case the impulse-type display mode is being utilized, the effect of eliminating blurring phenomenon is better than the previously mentioned methods. However, this method still has a drawback that the total brightness of the pixel is not the same during the first frame time T₁ and the second frame time T₂.

As mentioned above, the technologies such as the liquid crystal materials with fast response time, the over-driving, and the blinking backlight module, or even the combinations of them can not totally solve the blurring phenomenon. Therefore, it is an important subject to provide a video display driving method that can completely eliminate the blurring phenomenon of an LCD.

### SUMMARY OF THE INVENTION

In view of the foregoing, the invention is to provide a video display driving method that can completely remove the blurring phenomenon of an LCD.

To achieve the above, a video display driving method of an LCD according to the invention comprises a data transforming process, a display driving process, and a light controlling process. The data transforming process transforms sets of video frame data into plural preset voltage signal sets and plural post-set voltage signal sets for driving the pixels. The preset voltage signal sets comprises a first preset voltage signal set and a second preset voltage signal set, and the post-set voltage signal sets comprises a first post-set voltage signal set and a second post-set voltage signal set. The display driving process writes at least one preset voltage signal of the first preset voltage signal set and at least one post-set voltage signal of the first post-set voltage signal set into at least one of the pixels of the LCD panel in sequence during a frame time. Then, the display driving process writes at least one preset voltage signal of the second preset voltage signal set and at least one post-set voltage signal of the second post-set voltage signal set into the pixel of the LCD panel in sequence during a next frame time. The light controlling process controls the brightness of the light source of a backlight module, so that the location of the pixel presents a first average brightness during a period between the time when the preset voltage signal of the first preset voltage signal set is written into the pixel and the time when the post-set voltage signal of the first post-set voltage signal set is written into the pixel, and presents a second average brightness during a period between the time when the post-set voltage signal of the first post-set voltage signal set is written into the pixel and the time when the preset voltage signal of the second preset voltage signal set is written into the pixel. Wherein, the second average brightness is greater than the first average brightness.

As mentioned above, the video display driving method of an LCD of the invention utilizes the over-driving technology and the technology of blinkingly-driven light-emitting elements of the backlight module. Thus, a preset voltage signal and a post-set voltage signal can be written into a pixel during a frame time in sequence, and the light-emitting elements of the backlight module can be blinkingly driven so as to present the most proper brightness variation. Accordingly, the invention can solve the blurring phenomenon caused by the slow response time of the liquid crystal material and the holding type display mode.

### BRIEF DESCRIPTION OF THE DRAWINGS

The invention will become more fully understood from the detailed description given herein below illustration only, and thus is not limitative of the present invention, and wherein:

FIG. 1 is a sectional schematic view of the conventional LCD;

FIG. 2A is a schematic view showing the variation of driving voltage for a pixel with utilizing the conventional video display driving method of the LCD;

FIG. 2B is a schematic view showing the variation of the transmittance of the pixel in the displaying surface, which is driven by the voltage shown in FIG. 2A, wherein the continuous line shows the pixel has a liquid crystal material with slower response time, and the dotted line shows the pixel has a liquid crystal material with faster response time;

FIG. 2C is a schematic view showing the variation of luminance emitted from the backlight module at the location where the pixel is;

FIG. 2D is a schematic view showing the brightness of the pixel on the displaying surface;

FIG. 3A is a schematic view showing the variation of driving voltage for a pixel with utilizing another conventional video display driving method of the LCD;

FIG. 3B is a schematic view showing the variation of the transmittance of the pixel in the displaying surface, which is driven by the voltage shown in FIG. 3A;

FIG. 3C is a schematic view showing the luminance of the location of the pixel emitted from the backlight module;

FIG. 3D is a schematic view showing the brightness of the pixel on the displaying surface;

FIG. 4A is a schematic view showing the variation of driving voltage for a pixel with utilizing yet another conventional video display driving method of the LCD;

FIG. 4B is a schematic view showing the variation of the transmittance of the pixel in the displaying surface, which is driven by the voltage shown in FIG. 4A;

FIG. 4C is a schematic view showing the variation of luminance emitted from the backlight module at the location where the pixel is;

FIG. 4D is a schematic view showing the brightness of the pixel on the displaying surface;

FIG. 5A is a schematic view showing the variation of driving voltage for a pixel with utilizing a video display driving method of an LCD according to a preferred embodiment of the invention;

FIG. 5B is a schematic view showing the variation of the transmittance of the pixel in the displaying surface, which is driven by the voltage shown in FIG. 5A;

FIG. 5C is a schematic view showing the variation of luminance emitted from the backlight module at the location where the pixel is;

FIG. 5D is a schematic view showing the brightness of the pixel on the displaying surface; and

FIG. 6 is a flowchart showing the processes of a video display driving method of an LCD according to a preferred embodiment of the invention.

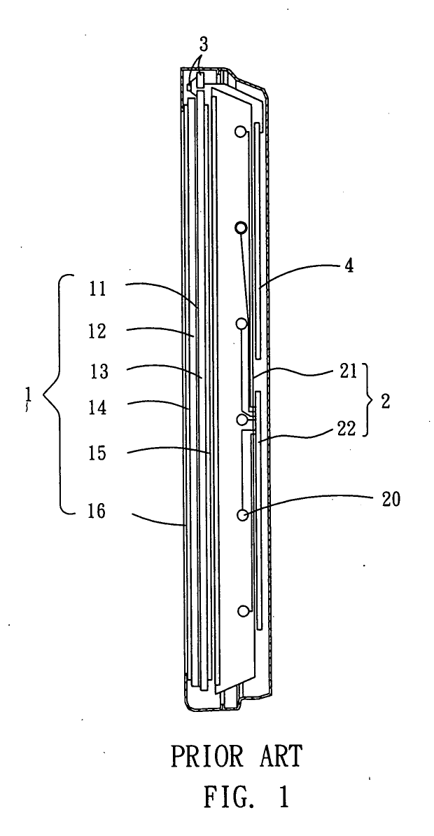

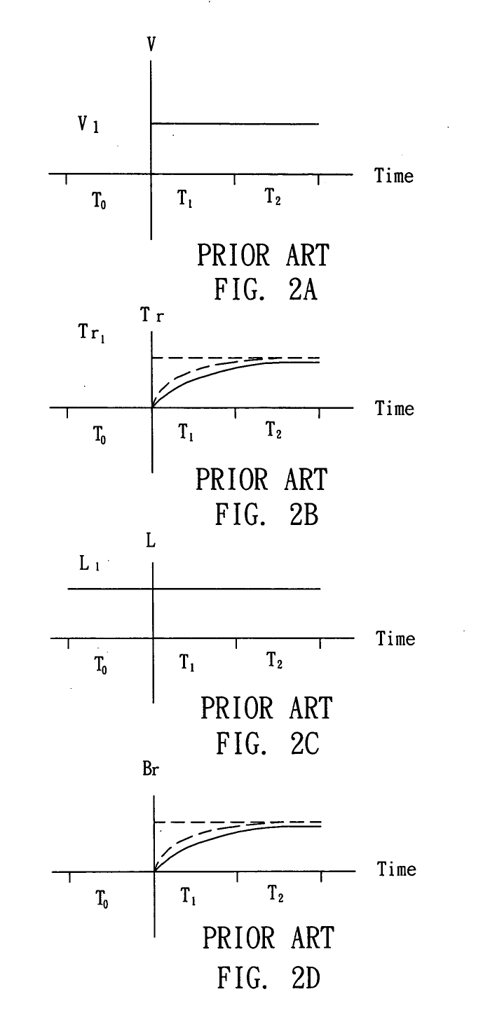

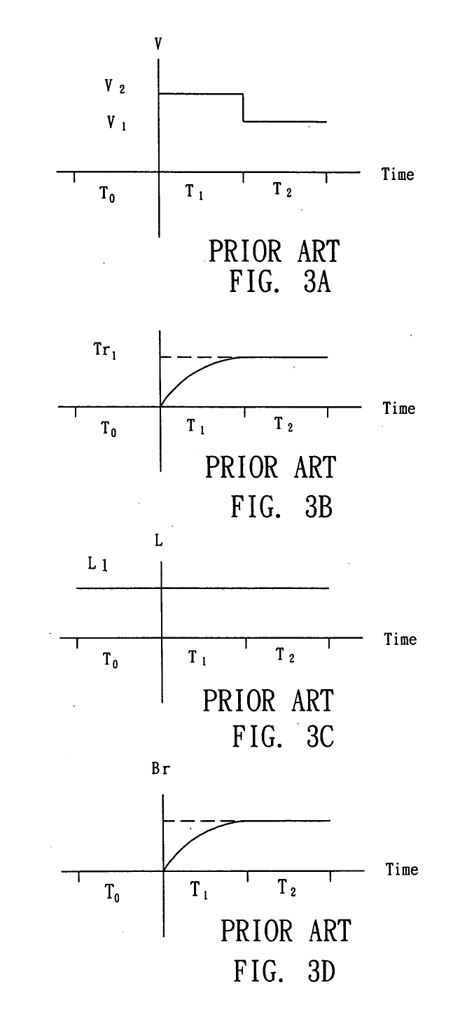

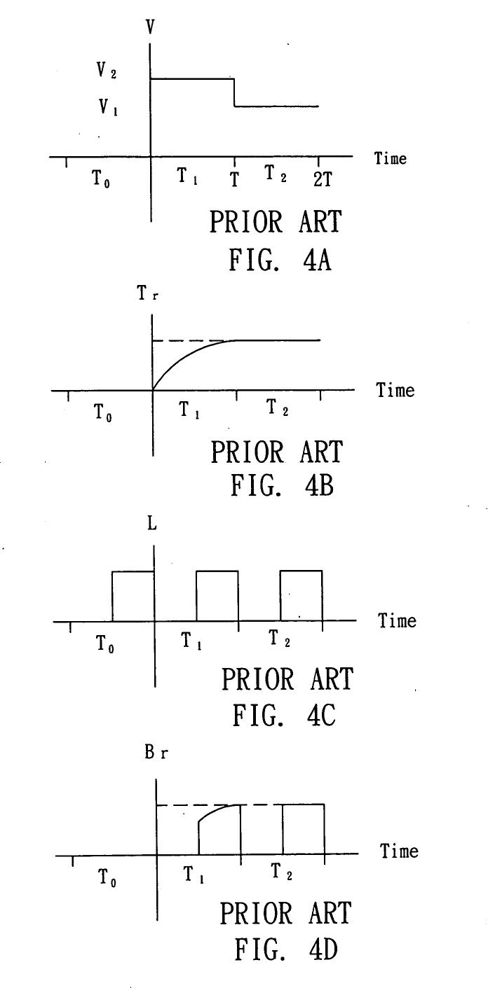

### DETAILED DESCRIPTION OF THE INVENTION

The present invention will be apparent from the following detailed description, which proceeds with reference to the accompanying drawings, wherein the same references relate to the same elements.

In the following embodiment, the LCD can be an LCD TV or a common LCD monitor. To make the descriptions more comprehensive, the relative references of the LCD described in the related art will be used again. The LCD comprises an LCD panel 1 and a backlight module 2. The LCD panel 1 includes a plurality of pixels, which are distributed on a displaying surface 16 of the LCD panel 1. The LCD panel 1 receives plural sets of video frame data, and a light source of the backlight module 2 projects light onto the displaying surface 16 of the LCD panel 1. Moreover, the description of the following embodiment is to drive one pixel, and three continuous sets of video frame data on the pixel, for example, have the corresponding driving voltage of 0, V₁ and V₂.

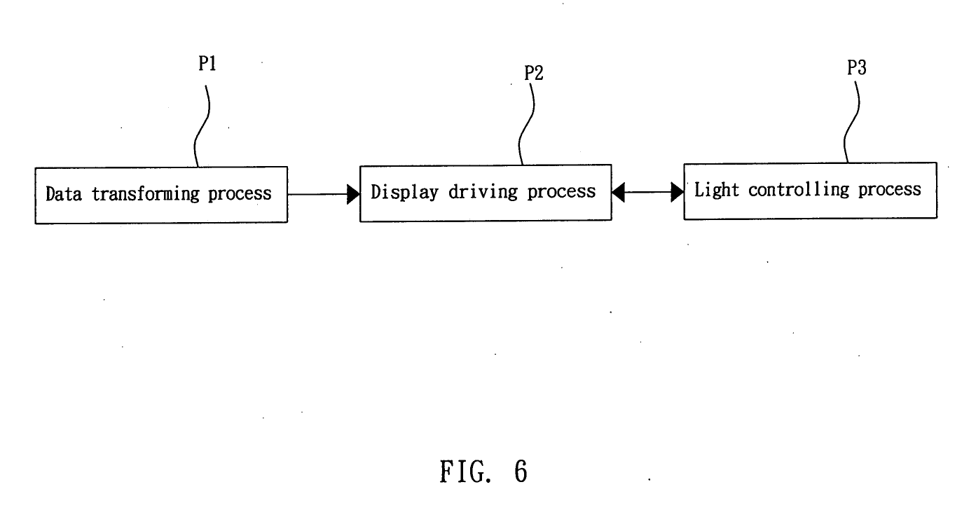

With reference to FIG. 6, a video display driving method of an LCD according to a preferred embodiment of the invention comprises a data transforming process P1, a display driving process P2, and a light controlling process P3.

The data transforming process P1 is to transform plural sets of video frame data, which are inputted from outside, into plural preset voltage signal sets and plural post-set voltage signal sets for driving the pixels. In this case, each set of video frame data corresponds to one preset voltage signal set and one post-set voltage signal set. One preset voltage signal of each preset voltage signal set corresponds to one post-set voltage signal of the post-set voltage signal set corresponding to the same set of video frame data. In this embodiment, each preset voltage signal set transformed from one of the sets of video frame data is an over-driving voltage signal set of the post-set voltage signal set transformed from the same set of video frame data. For example, the preset voltage signal sets comprises a first preset voltage signal set and a second preset voltage signal set, and the post-set voltage signal sets comprises a first post-set voltage signal set and a second post-set voltage signal set.

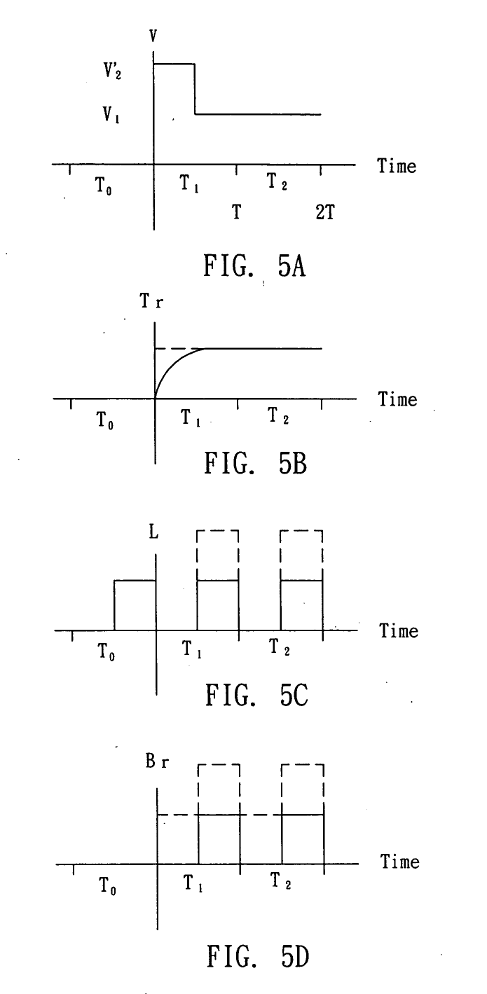

With reference to FIG. 5A, the display driving process P2 is to write at least one preset voltage signal of the first preset voltage signal set and at least one post-set voltage signal of the first post-set voltage signal set into at least one pixel of the LCD panel 1 in sequence during a first frame time T₁, and then to write at least one preset voltage signal of the second preset voltage signal set and at least one post-set voltage signal of the second post-set voltage signal set into the pixel of the LCD panel 1 in sequence during a second frame time T₂ next to the first frame time T₁. That is, during the first frame time T₁, one preset voltage signal of the first preset voltage signal set is written firstly, and the preset voltage signal is used to drive the pixel during the first half (T₁/2) of the first frame time T₁. Then, during the first frame time T₁, one post-set voltage signal of the first post-set voltage signal set is written, and the post-set voltage signal is used to drive the pixel during the second half (T₁/2) of the first frame time T₁. In addition, during the second frame time T₂, one preset voltage signal of the second preset voltage signal set is written, and the preset voltage signal is used to drive the pixel during the first half (T₂/2) of the second frame time T₂. Then, during the second frame time T₂, one post-set voltage signal of the second post-set voltage signal set is written, and the post-set voltage signal is used to drive the pixel during the second half (T₂/2) of the second frame time T₂. In this embodiment, the preset voltage signal of the first preset voltage signal set is V₂′ and the post-set voltage signal of the first post-set voltage signal set is V₁. The preset voltage signal of the second preset voltage signal set and the post-set voltage signal of the second post-set voltage signal set are both V₁. As shown in FIG. 5B, the transmittance of the pixel can almost reach the desired transmittance Tr₁ corresponding to the voltage signal V₁ before the end of the first half (T₁/2) of the first frame time T₁. In the display driving process P2 of the embodiment, the period between the time when the preset voltage signal is written into the pixel and the time when the corresponding post-set voltage signal is written into the pixel is equal to a half of the frame time (T₂/2 or T₂/2). In other words, the video display driving method of the invention has two write procedures in a frame time, and uses the over-driving voltage signal to drive the pixel before the first half of the frame time. To be noted, in the display driving process P2, the preset voltage signal of the second preset voltage signal set and the post-set voltage signal of the second post-set voltage signal set are both V₁. In other words, regarding to the same pixel, assuming the voltages to be written in two continuous frames are the same, the voltage of the preset voltage signal, which is equal to the over-driving voltage signal, should be equal to that of the post-set voltage signal.

The light controlling process P3 controls the brightness of at least one light-emitting element of the backlight module, so that at the location of the pixel a first average brightness is produced during a period between the time when the preset voltage signal of the first preset voltage signal set is written into the pixel and when the post-set voltage signal of the first post-set voltage signal set is written into the pixel and a second average brightness is produced during a period between the time when the post-set voltage signal of the first post-set voltage signal set is written into the pixel and when the preset voltage signal of the second preset voltage signal set is written into the pixel. In the current embodiment, the second average brightness is greater than the first average brightness. The light controlling process P3 is to control the brightness of the light-emitting element(s) closest to the pixel. In other words, the light control process P3 is to decrease the brightness of at least one light-emitting element of the backlight module during the period between when the preset voltage signal of the first preset voltage signal set is written into the pixel and when the post-set voltage signal of the first post-set voltage signal set is written into the pixel, and to increase the brightness of at least one light-emitting element of the backlight module during the period between when the post-set voltage signal of the first post-set voltage signal set is written into the pixel and when the preset voltage signal of the second preset voltage signal set is written into the pixel. As shown in FIG. 5C, assuming the luminance of the lamps 211 is L₁ and the duty cycle is 50% of the frame time for blinking illumination, the brightness of the pixel on the displaying surface 16 is as shown in FIG. 5D. In such a case, the first average brightness is 0, and the second average brightness is L₁. Of course, the first average brightness in real cases is not required to be 0 since other lamps next to the lamp 211 which is closest to the pixel may also emit light to illuminate the pixel. In practice, if the first average brightness is less than 20% of the second average brightness, the blurring phenomenon removal can be outstandingly improved. In addition, since the duty cycle is 50% of the frame time for blinking illumination, the average brightness of the display surface 16 is decreased. Regarding to this issue, we can properly adjust the intensity of driving current to increase the illumination (as the dotted line shown in FIG. 5C). Accordingly, the average brightness of the displaying surface 16 can be increased (as the dotted line shown in FIG. 5D).

To be noted, in the present embodiment, the backlight module is a direct type backlight module, and, of course, it can also be an edge type backlight module. The light-emitting elements of the backlight module are cold cathode fluorescent lamps (CCFL), and, of course, they can also be hot cathode fluorescent lamps, light-emitting diodes (LED), flat fluorescent lamps (FFL), or external electrode fluorescent lamps (EEFL). Besides, the range of the frame time of this embodiment is:
1/50 second≧the frame time≧ 1/120 second.

In general, the frame time is equal to 1/60 second.

In summary, the video display driving method of an LCD of the invention utilizes the over-driving technology and the technology of blinkingly-driven light-emitting elements of the backlight module. Thus, a preset voltage signal and a post-set voltage signal can be written into a pixel during a frame time in sequence, and the light-emitting elements of the backlight module can be blinkingly driven. Accordingly, the invention can solve the blurring phenomenon caused by the slow response time of the liquid crystal material and the holding type display mode.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A video display driving method of an LCD (Liquid Crystal Device), wherein the LCD comprises an LCD panel and a backlight module, the LCD panel has a plurality of pixels distributed on a displaying surface of the LCD panel, the LCD panel receives plural sets of video frame data, and a light source of the backlight module projects light onto the displaying surface of the LCD panel, the video display driving method comprising:
a data transforming process, which transforms the sets of video frame data into plural preset voltage signal sets and plural post-set voltage signal sets for driving the pixels, wherein the preset voltage signal sets comprises a first preset voltage signal set and a second preset voltage signal set, and the post-set voltage signal sets comprises a first post-set voltage signal set and a second post-set voltage signal set;
a display driving process, which writes at least one preset voltage signal of the first preset voltage signal set and at least one post-set voltage signal of the first post-set voltage signal set into at least one of the pixels of the LCD panel in sequence during a frame time, and then writes at least one preset voltage signal of the second preset voltage signal set and at least one post-set voltage signal of the second post-set voltage signal set into the pixel of the LCD panel in sequence during a next frame time; and
a light controlling process, which controls the brightness of the light source of the backlight module, so that at the location of the pixel a first average brightness is produced during a period between when the preset voltage signal of the first preset voltage signal set is written into the pixel and when the post-set voltage signal of the first post-set voltage signal set is written into the pixel and a second average brightness is produced during a period between when the post-set voltage signal of the first post-set voltage signal set is written into the pixel and when the preset voltage signal of the second preset voltage signal set is written into the pixel, wherein the second average brightness is greater than the first average brightness.

2. The video display driving method of claim 1, wherein the first average brightness is less than 20% of the second average brightness.

3. The video display driving method of claim 1, wherein one of the preset voltage signal sets transformed from one of the sets of video frame data is an over-driving voltage signal set of the corresponding post-set voltage signal set transformed from the same set of video frame data.

4. The video display driving method of claim 1, wherein the backlight module comprises a plurality of light-emitting elements.

5. The video display driving method of claim 4, wherein the light controlling process is to decrease the brightness of at least one of the light-emitting elements of the backlight module during the period between when the preset voltage signal of the first preset voltage signal set is written into the pixel and when the post-set voltage signal of the first post-set voltage signal set is written into the pixel, and to increase the brightness of at least one of the light-emitting elements of the backlight module during the period between when the post-set voltage signal of the first post-set voltage signal set is written into the pixel and when the preset voltage signal of the second preset voltage signal set is written into the pixel.

6. The video display driving method of claim 5, wherein the light-emitting element with the decreased brightness is the one light-emitting element closest to the pixel.

7. The video display driving method of claim 5, wherein the light-emitting element with the increased brightness is the one light-emitting element closest to the pixel.

8. The video display driving method of claim 4, wherein the light-emitting elements of the backlight module are cold cathode fluorescent lamps (CCFL).

9. The video display driving method of claim 4, wherein the light-emitting elements of the backlight module are hot cathode fluorescent lamps.

10. The video display driving method of claim 4, wherein the light-emitting elements of the backlight module are light-emitting diodes (LED).

11. The video display driving method of claim 4, wherein the light-emitting elements of the backlight module are flat fluorescent lamps (FFL).

12. The video display driving method of claim 4, wherein the light-emitting elements of the backlight module are external electrode fluorescent lamps (EEFL).

13. The video display driving method of claim 1, wherein the period between when the preset voltage signal is written into the pixel and when the corresponding post-set voltage signal is written into the pixel is equal to a half of the frame time.

14. The video display driving method of claim 1, wherein:
1/50 second≧the frame time≧ 1/120 second.

15. The video display driving method of claim 1, wherein the backlight module is a direct type backlight module.

16. The video display driving method of claim 1, wherein the backlight module is an edge type backlight module.

17. The video display driving method of claim 1, wherein the LCD is an LCD TV.

18. The video display driving method of claim 1, wherein the LCD is an LCD monitor.
